(19) United States
(12) Patent Application Publication
(10) Pub. No.: US 2009/0050760 A1
(43) Pub. Date: Feb. 26, 2009

(54) ADJUSTABLE MOUNTING FOR FLAT PANEL DISPLAYS

(75) Inventor: Simon Peter Duff, New South Wales (AU)

Correspondence Address: VANGELIS ECONOMOU;C/O IPHORGAN LTD, 1130 LAKE COOK ROAD, SUITE 2400, BUFALLO GROVE, IL, 60089, US

(73) Assignee: ATDEC PTY LIMITED, Bankstown (AU)

(21) Appl. No.: 11/659,397

(22) PCT Filed: Jul. 7, 2005
(86) PCT No.: PCT/AU2005/000996

§ 371 Date: Oct. 29, 2008

(30) Foreign Application Priority Data
Jul. 30, 2004 (AU) 2004 904 291

(51) Int. Cl. A47F 5/08; F16M 13/00

(52) U.S. Cl. 248/231.91

(57) ABSTRACT

An adjustable mounting (10) for a panel display includes a housing 11 having a central portion (12) and four outwardly directed housing arms (13, 14, 15 and 16) each adapted to receive an adjustable fixing arm (17, 18, 19 and 20). The fixing arms (17, 18, 19 and 20) are extendable between a first or inner position and a second or outer position, each fixing arm has a fixing aperture (29) at its outer end by means of which the mounting is secured to the panel display. The fixing apertures (29) may be at the corners of a square 75 mm×75 mm or a square 100 mm×100 mm or a rectangle 100 mm×200 mm.

### TECHNICAL FIELD

This invention relates to an adjustable mounting and, more particularly, to an adjustable mounting for flat panel displays.

### BACKGROUND ART

For the sake of convenience, the invention will be described in relation to Video Electronic Standards Association (VESA) compliant wall mountings for flat panel displays such as plasma displays, LCD displays or TFT displays. However, it is to be understood that the mounting system of the invention is not limited to such displays as is applicable to the mounting of other generally flat objects.

With the decreasing price of many flat panel displays employing plasma technology, liquid crystal displays or other electronic techniques such as are employed in TFT displays, there is an increasing need for a mounting for these flat panel displays which will accommodate different mounting geometries of similar displays.

Many displays comply with either one of VESA's 100 mm or 75 mm mounting whole standards (which refer to the distance between the mounting holes on VESA compliant displays). As a consequence, the prior art consists of either a mounting specifically designed to fit a certain size or display or one which has two sets of mounting apertures.

### SUMMARY OF THE INVENTION

According to one aspect of the invention there is provided an adjustable mounting comprising a housing having a central portion from which extends a plurality of fixing arms, the fixing arms being extendable between a first or inner position and a second or outer position.

In a preferred form of the invention, the fixing arms are slidable with respect to the housing and the first position corresponds to the 75 mm VESA mounting standard and the second position corresponds to the 100 mm VESA mounting standard.

Preferably, the body of each fixing arm has an elongated recess which terminates in an inner opening. The movement of the fixing arms may be controlled by a backing plate having arms which terminate in a locking lug, the locking lugs being located in the elongated recesses of the fixing legs.

In a further preferred form of the invention, the fixing arms are extendable between an inner position, an intermediate position and an outer position.

It is also preferred that there are four fixing arms and each fixing arm has a fixing aperture at its outer end by means of which the mounting is secured to the display. The fixing arms may be pivotally mounted on the housing to accommodate the geometry of the fixing apertures lying at the corners of a square or a rectangle.

Thus, the fixing apertures can lie at the corners of, for example, a square 75 mm×75 mm, a square 100 mm×100 mm and a rectangle 100 mm×200 mm.

### BRIEF DESCRIPTION OF THE DRAWINGS

FIG. 1 is an exploded rear perspective view of an adjustable mounting according to one embodiment of the invention,

FIG. 2 is a rear view of the mounting shown in FIG. 1 with the fixing legs set for the 75 mm VESA standard,

FIG. 3 is an enlarged cross sectional view taken along lines A-A of FIG. 2,

FIG. 4 is a front perspective view of the mounting shown in FIG. 2,

FIG. 5 is a perspective view of the mounting shown in FIG. 4 being fixed to a display,

FIG. 6 is a perspective view of the mounting shown in FIGS. 1 and 4 with the fixing legs set for the 100 mm VESA standard,

FIG. 7 is a perspective view of the mounting shown in FIG. 6 being fixed to a display,

FIG. 8 is a rear view of the mounting shown in FIG. 6,

FIG. 9 is an enlarged view of the portion A of FIG. 8,

FIG. 10 is a front perspective view of an adjustable mounting according to a second embodiment of the invention with the fixing arms at their inner position,

FIG. 11 is a view similar to FIG. 10 with the fixing arms at their intermediate position, and

FIG. 12 is a view similar to FIG. 10 with the fixing arms at their outer position and pivoted with respect to one another.

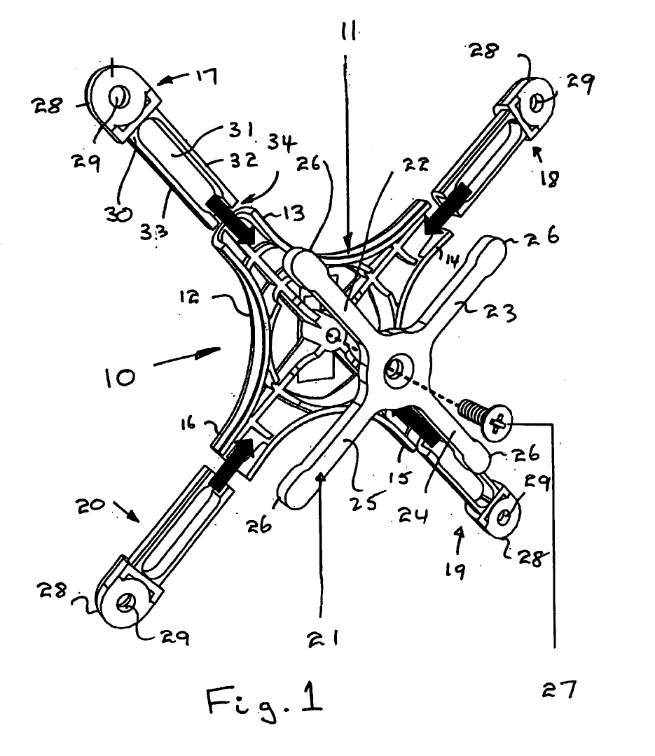

### MODES FOR CARRYING OUT THE INVENTION

The adjustable mounting 10 shown in the drawings includes a housing 11 having a central portion 12 and, in this instance, four outwardly directed housing arms 13, 14, and 16, each adapted to receive an adjustable fixing arm 17, 18, 19 and 20.

A backing plate 21 has four arms 22, 23, 24 and 25, each of which terminate in a locking lug 26. The backing plate 21 is secured to the central portion 12 of the housing 11 by screw 27.

Each fixing arm 17, 18, 19 and 20 has an outer mounting boss 28 having a fixing aperture 29 for receiving a mounting screw by means of which the mounting 10 is secured to the display. The body 30 of each fixing arm 17, 18, 19 and 20 has an elongated recess 31 defined by leg portions 32 and 33 which terminate in an opening 34 through which the backing plate arms 22, 23, 24 and 25 extend so that the lugs 26 are located in the elongated recesses 30.

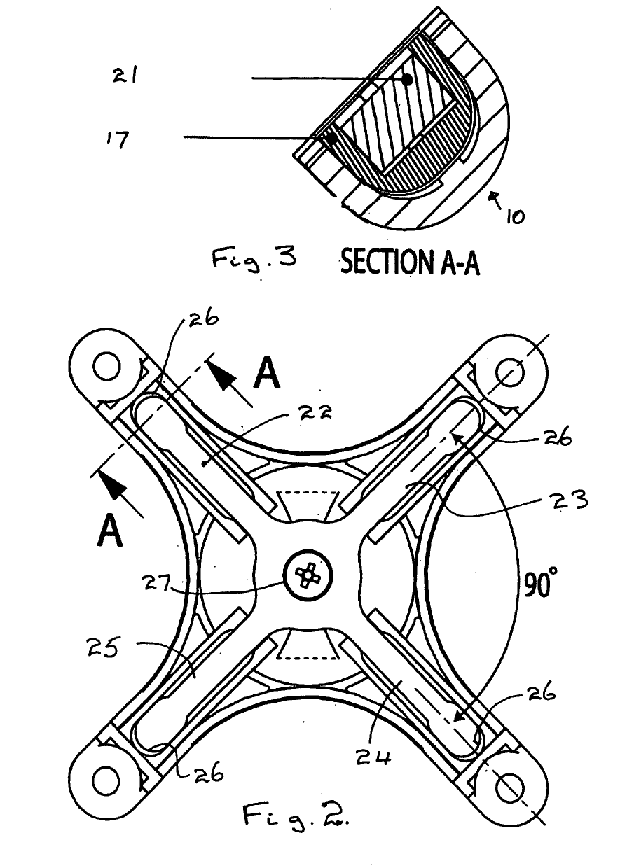

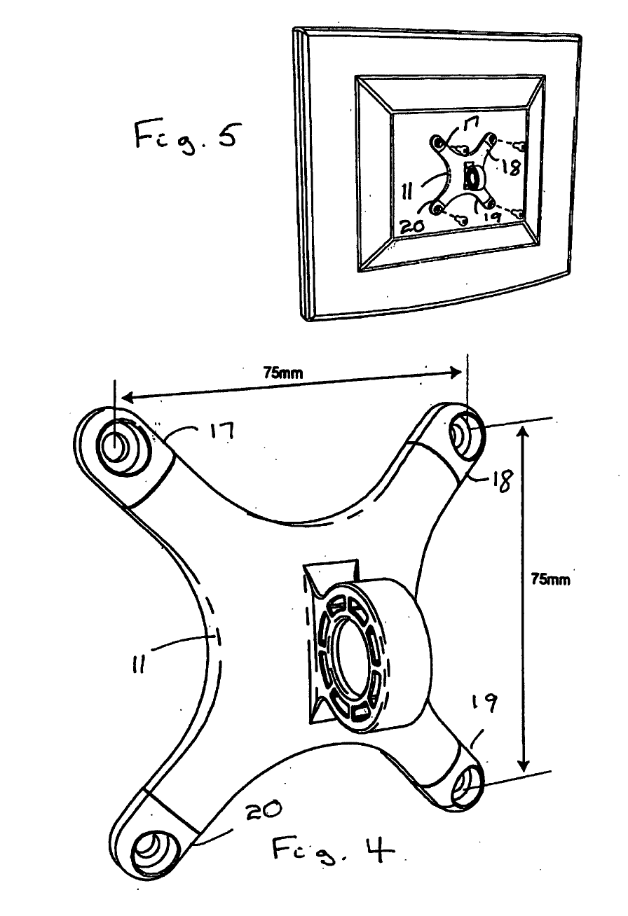

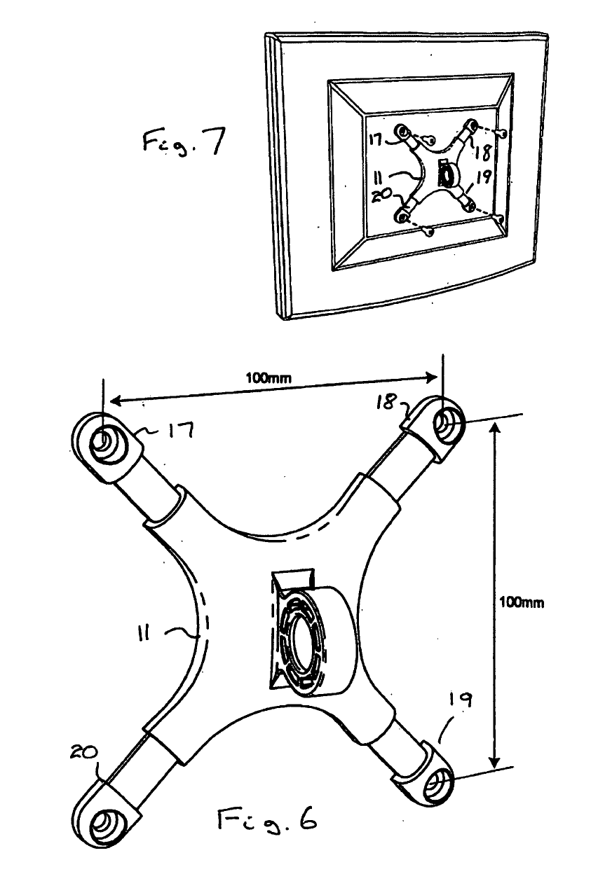

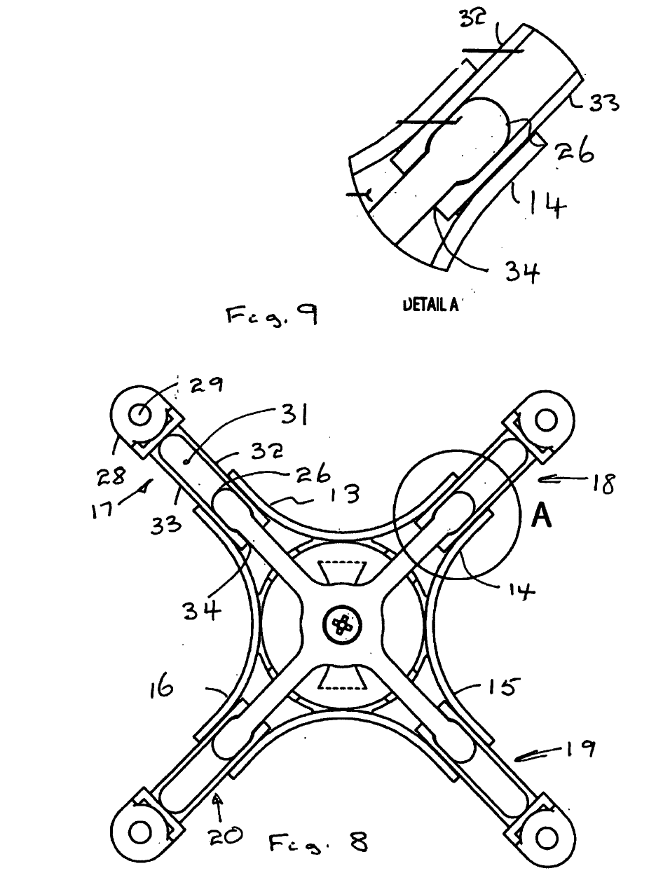

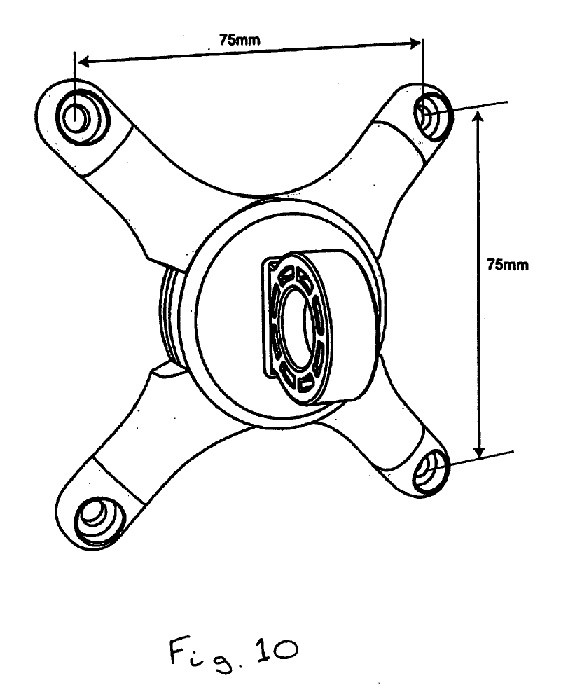

The leg portions 32 and 33 of each fixing arm 17 to 20 is received in one of the housing arms 13 to 16 as shown in FIG. 2. The fixing arms 17 to 20 can be moved inwardly and outwardly of the lugs 26 so that the fixing apertures 29 can be set for the 75 mm VESA standard as shown in FIGS. 2 and 4 or the 100 mm VESA standard as shown in FIGS. 6 and 8. The length of travel of the fixing arms with respect to the legs of the backing plate is governed by the length of the recesses 31.

As will be apparent from the foregoing description, the invention provides a mounting which is compliant with both the 75 mm and the 100 mm VESA standards by virtue of the movement of the fixing arms. With each fixing arm pushed completely inward until it sits against the housing, each fixing aperture is positioned 75 mm apart with the centre points creating a 75 mm square thereby complying with the 75 mm VESA mounting standard.

Each fixing arm is able to slide an equal distance outwards until they engage the fixing lugs at which point the mounting apertures are positioned 100 mm apart with centre points creating a 100 mm square complying with the 100 mm VESA mounting standard. This range of movement also allows the mounting to accommodate non-VESA mounting standards within the range of movement.

As will be apparent from the above description and the accompanying drawings, the outward travel of the fixing arms is restricted by the recesses 31. The shape of the backing plate is such that it travels freely within this recess until the point that the mounting apertures are positioned to suit the 100 mm VESA standard. At this point, the recess in each arm is reduced in width causing the lug of the backing plate to come in contact with the arm and restrict the arm from further travel.

Although the invention has been described in relation to the sliding movement of the fixing arms, the different VESA mounting standards could be accommodated by utilising fixing arms which are pivoted to the housing offset from their centre so that in one configuration the longer portion of the fixing arm would be outward of the pivot point to provide the 100 mm VESA standard and in the other configuration the shorter part of the fixing arm would provide the 75 mm VESA standard.

In another embodiment of the invention, the fixing legs could be arranged so that they can be folded inwardly to create the 75 mm VESA standard and folded outwardly to create the 100 mm VESA standard.

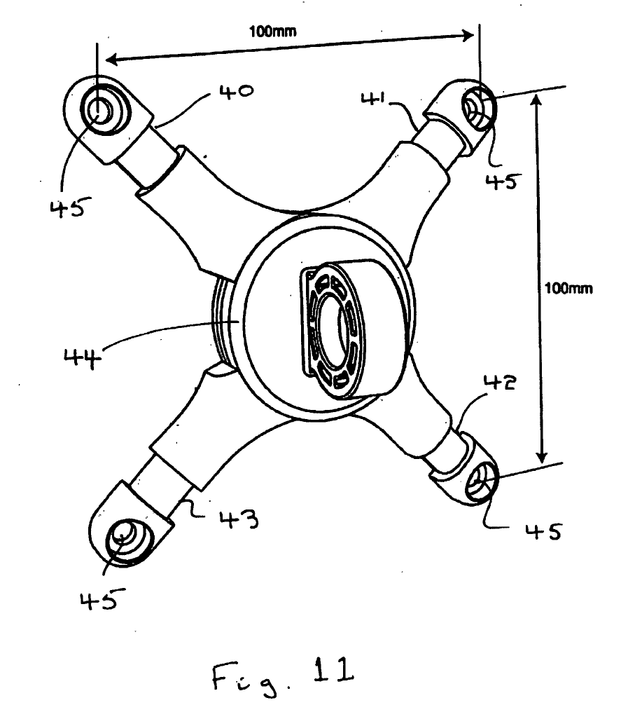

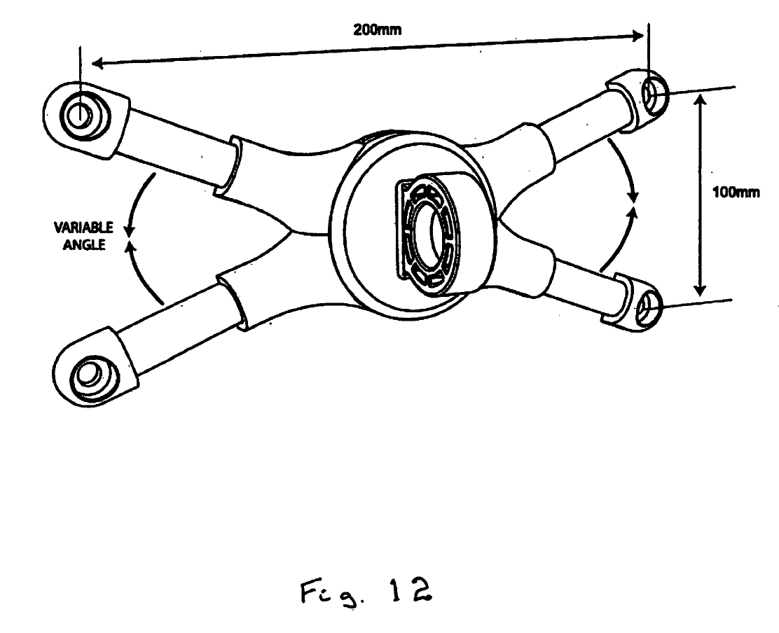

The embodiment of the invention shown in FIGS. 10 to 12 is substantially the same as the first embodiment of the invention except that the arms 40, 41, 42 and 43 are pivotally mounted to the housing 44. In addition, the arms 40, 41, 42 and 43 are extendable between an inner position, an intermediate position and an outer position so that the fixing apertures can lie on a 75 mm×75 mm square as shown in FIG. 10, a 100 mm×100 mm square as shown in FIG. 11 and a 100 mm×200 mm rectangle as shown in FIG. 12.

Various modifications may be made in details of design and construction without departing from the scope and ambit of the invention.

1. An adjustable mounting for a panel display comprising a housing having a central portion from which extends a plurality of fixing arms, the fixing arms being extendable between a first or inner position and a second or outer position.

2. An adjustable mounting as claimed in claim 1 wherein the fixing arms are slidable with respect to the housing and the first position corresponds to the 75 mm VESA mounting standard and the second position corresponds to the 100 mm VESA mounting standard.

3. An adjustable mounting as claimed in claim 1 wherein the body of each fixing arm has an elongated recess which terminates in an inner opening.

4. An adjustable mounting as claimed in claim 3 wherein the movement of the fixing arms may be controlled by a backing plate having arms which terminate in a locking lug, the locking lugs being located in the elongated recesses of the fixing legs.

5. An adjustable mounting as claimed in claim 1 wherein the fixing arms are extendable between an inner position, an intermediate position and an outer position.

6. An adjustable mounting as claimed in claim 1 including four fixing arms and wherein each fixing arm has a fixing aperture at its outer end by means of which the mounting is secured to the display.

7. An adjustable mounting as claimed in claim 6 wherein the fixing arms are pivotally mounted on the housing to accommodate the geometry of the fixing apertures lying at the corners of a square or a rectangle.

8. An adjustable mounting as claimed in claim 7 wherein the fixing apertures lie at the corners of a square 75 mm×75 mm, or a square 100 mm×100 mm or a rectangle 100 mm×200 mm.
